(19) United States
(12) Patent Application Publication
(10) Pub. No.: US 2021/0064621 A1
(43) Pub. Date: Mar. 4, 2021

(54) OPTIMIZING METHOD OF SEARCH FORMULA FOR PATENT DOCUMENT AND DEVICE THEREFOR

(71) Applicant: WERTINTELLIGENCE, Seoul (KR)

(72) Inventor: jungho YUN, Seoul (KR)

(73) Assignee: WERTINTELLIGENCE, Seoul (KR)

(21) Appl. No.: 17/012,681

(22) Filed: Sep. 4, 2020

(30) Foreign Application Priority Data
Sep. 4, 2019 (KR) 10-2019-0109560

(51) Int. Cl. G06F 16/2453; G06F 16/2455; G06F 16/28; G06F 16/248; G06F 16/22

(52) U.S. Cl. CPC G06F 16/24549; G06F 16/24558; G06F 16/2282; G06F 16/287; G06F 16/248; G06F 16/24539

(57) ABSTRACT

The present disclosure provides an optimization method for a patent literature search formula, including: a step of receiving the patent literature search formula; a step of classifying the received patent literature search formula into a plurality of groups based on a preset search operator; a step of adding at least one search word having a high-degree of relevance to each search word included in each classified group by using a first search operator; a step of generating a first final search formula by connecting and combining, with a second search operator, a plurality of groups to which the at least one search word is added; and a step of providing a user with the first final search formula.

### CROSS-REFERENCE TO RELATED APPLICATIONS

The present application claims priority under 35 U.S.C 119(a) to Korean Patent Application No. 10-2019-0109560, filed on Sep. 4, 2019, which is incorporated herein by reference in its entirety.

### BACKGROUND

### 1. Technical Field

The present disclosure relates to a method for optimizing/expanding a patent literature search formula, an apparatus, and a server therefor.

### 2. Related Art

Patent literature search technology/system are being used in various fields such as prior art investigation, patent value evaluation, and patent invalidation investigation. In such patent literature search technology/system, in order to search for a patent literature desired by a user without omission (for example, in order to improve the quality of a patent literature search result), it is very important to create a high-quality patent literature search formula.

However, it is very difficult for the general public (non-expert) to create a patent literature search formula based on technical terms. Furthermore, even for an expert, since all technical terms cannot be known and types of patent search operators are very diverse, it is very difficult to create a high-quality patent literature search formula for searching so as not to omit any one of patent literatures.

Accordingly, various methods have been developed so that not only the expert but also the general public (non-expert) may create a patent literature search formula well, and Korean Patent No. 10-1103773 exists as the prior art.

### SUMMARY

An object of the present disclosure is to provide a higher-quality patent literature search service by optimizing and expanding a patent literature search formula input by a user to a high-quality patent literature search formula as if created by an expert, and providing the patent literature search formula to the user.

According to an example of the present disclosure, there is provided an optimization method for a patent literature search formula, including: a step of receiving the patent literature search formula; a step of classifying the received patent literature search formula into a plurality of groups based on a preset search operator; a step of adding at least one search word having a high-degree of relevance to each search word included in each classified group by using a first search operator; a step of generating a first final search formula by connecting and combining, with a second search operator, a plurality of groups to which the at least one search word is added; and a step of providing a user with the first final search formula.

According to an example of the present disclosure, since the patent literature search formula is expanded and optimized to be provided to the user, the user may search for the patent literature he/she is looking for without omission, and thereby there is an effect that a high-quality patent search service may be provided.

In addition, according to an example of the present disclosure, since the patent literature search formula is optimized by using various search operators, the user does not need to be familiar with all complex search operators, so that there is an effect of reducing the time and the cost such as effort required to create the patent literature search formula.

### BRIEF DESCRIPTION OF THE DRAWINGS

Various embodiments of the present disclosure will become more apparent in view of the attached drawings and accompanying detailed description, in which:

FIG. 1 is a flowchart illustrating an optimization method for a patent literature search formula according to an example of the present disclosure;

FIG. 2 is a diagram illustrating a screen configuration user interface (UI) for providing the optimization method for the search formula according to an example of the present disclosure;

FIG. 3 is a diagram illustrating a screen configuration UI for providing a search formula optimization result according to an example of the present disclosure;

FIG. 4 is a table illustrating an arrangement of first and second final search formulas which are optimization and expansion results of the patent literature search formula input by a user according to an example of the present disclosure;

FIG. 5 is a diagram illustrating an example of a search word expansion function according to an example of the present disclosure;

FIG. 6 is a diagram illustrating an example of a search formula assistance UI according to an example of the present disclosure;

FIG. 7 is a diagram illustrating an example of a search word recommendation UI according to an example of the present disclosure; and

FIG. 8 is a block diagram of a search formula optimization server according to an example of the present disclosure.

### DETAILED DESCRIPTION OF THE EMBODIMENTS

The technology described below may be modified in various ways and may have various examples, and specific examples will be illustrated in the drawings and described in detail. However, this is not intended to limit the technology to be described below with respect to specific examples, and it should be understood to include all changes, equivalents, and substitutes included in the idea and scope of the technology described below.

Terms such as first, second, A, B, and the like may be used to describe various configuration elements, but the configuration elements are not limited by the terms described above, and are only for the purpose of distinguishing one configuration element from other configuration elements. For example, without departing from the scope of the rights of the technology described below, a first configuration element may be referred to as a second configuration element, and similarly, a second configuration element may be referred to as a first configuration element. The term ‘and/or’ includes a combination of a plurality of related listed items or any of a plurality of related listed items. For example, ‘A and/or B’ may be interpreted as meaning ‘at least one of A or B’. Also, ‘/’ may be interpreted as ‘and’ or ‘or’.

In terms of being used in this specification, a singular expression is to be understood as including plural expressions unless clearly interpreted differently in the context, and terms such as “include” are intended to mean the existence of features, numbers, steps, operations, configuration elements, parts, or combinations thereof, and are to be understood that it does not exclude a possibility of the existence or addition of one or more other features or numbers, steps, operations, configuration elements, parts, or combinations thereof.

Prior to the detailed description of the drawings, it is intended to clarify that the classification of the configuration portions in this specification is merely classified by a main function that each configuration portion is responsible for. That is, two or more configuration portions to be described below may be combined into one configuration portion, or one configuration portion may be classified into two or more configuration portions according to more subclassified functions. In addition, each of the configuration portions to be described below may additionally perform some or all of the functions of other configuration portions in addition to its own main function, and it goes without saying that some of the main functions of each configuration portion may be performed exclusively by another configuration portion.

In addition, in performing a method or an operation method, each of steps constituting the method may be performed differently from the specified order unless a specific order is clearly stated in the context. That is, each of the steps may be performed in the same order as specified, may be performed substantially simultaneously, or may be performed in the reverse order.

The present disclosure relates to optimization system/method/server/device for a patent literature search formula, and more particularly, the present disclosure aims/features to generate an optimal/high quality search formula including an optimal item field, a search word and/or a search operator by learning based on keywords, translated words, expert search formula record information, and synonym/similar word/synthetic word/compound word information of a search target database of the patent literature.

Users, who search for a professional literature such as the intellectual property of patents, scientific and technical literature, papers, trademarks, and designs, spend the most time and effort in generating a patent literature search formula having high validity without omission of the patent literature to be searched. This corresponds to an area where a gap among users is very large according to user-specific expertise, experience, or the like. Accordingly, an object of the present disclosure is to provide a search formula optimization service that may solve a field, operator use, and similar keyword recommendation at once by simply inputting a simple patent literature search formula without expert knowledge and experience, and as a result it is possible to generate effects of reducing the gap among users and lowering a threshold for generating a patent literature search formula.

That is, according to the present disclosure, anyone may input a simple patent literature search formula to complete an optimal patent literature search formula that seems to be generated by an expert. In particular, since the present disclosure automatically generates even a search operator according to a search logic that is not a simple search word/keyword recommendation, it is possible to implement a level of a patent literature search formula as generated by an actual expert without familiarizing himself/herself with complex search operators.

An execution subject of the examples to be described later may correspond to a patent literature search formula optimization device or server. In particular, the server may correspond to a web server that provides a patent literature search formula optimization service through the web or an application server that provides the patent literature search formula optimization service through an application. The patent literature search formula optimization device or server may be abbreviated respectively as a ‘search formula optimization device’ or a ‘search formula optimization server’. Hereinafter, for convenience of description, the execution subject of the example is referred to as the ‘search formula optimization server’ but is not limited thereto.

Since the present disclosure corresponds to an optimization method for a search formula, a basic search operator used in the search formula is defined as follows. However, a scope of the search operator to which the present disclosure is applied is not limited thereto, and it goes without saying that not only various conventional search operators used for search, but also newly defined search operators may be used.

The ‘and’ operator is a search operator for searching a literature including all of the target keywords and may be defined in the form of ‘and’. Therefore, when A and B are input, a patent literature including both A and B may be searched.

The ‘or’ operator is a search operator for searching a literature including any one of the target search words and may be defined in the form of ‘or’. Therefore, when A or B is input, a patent literature including A or B may be searched.

The item field operator is a search operator for designating/specifying/restricting a search range of a target search word to a specific data item of a patent literature and may be defined for each data item. The data item of the patent literature is an item corresponding to the bibliographic matter/information of the patent literature, and may include, for example, title of the disclosure, abstract, claim, independent claim, detailed description, background art, technical field, effect of the disclosure, drawing, the number, country, literature type, main international patent classification (IPC), legal status, similarity, grade, technical theme, publication number, registration number, patent number, publication date, registration date, registration publication date, application number, application date, priority number, priority date, expiration date of duration, applicant, applicant nationality, current right holder, current right holder nationality, inventor, inventor nationality, patent evaluation grade, rights grade, technology grade, utilization grade, family patent literature, citing literature, cited literature, depth of the claim, number of claim words, relationship of the claims, existence of lawsuit, type of lawsuit, and the like.

A parenthesis operator is a search operator that performs a function of grouping search words and search formulas and may be defined in a form of ‘( )’.

A negation operator is a search operator for searching for a literature that does not include a search word and may be defined in a form of ‘Not’. Therefore, when ‘Not A ‘is input, a patent literature in which A is not included may be searched.

A character limit operator is a search operator for setting the number (n) of characters included among target search words and may be defined in a form of ‘A/n’ or ‘N/n’. For example, when ‘A A/n B’ is input, a literature including n or less words between A and B may be searched. As another example, when ‘A N/n B’ is input, a literature including n or less words between A and B may be searched regardless of the order. In the former case, the order of A and B is considered when searching for literature.

A distance operator is a search operator for setting a distance among target search words and may be defined in a form of ‘near’ or ‘adj’. For example, when ‘A near B’ is input, a literature that is closely included between A and B less than a preset distance may be searched regardless of the order. As another example, when ‘A adj B’ is input, a literature that is closely included between A and B less than a preset distance may be searched. In the latter case, the order of A and B is considered when searching for a literature.

However, the character limit operator and the distance operator are not limited to the examples described above, and the number inserted into the operator may be defined as the number of words, morphemes, spaces, or distances among target search words. That is, the operator is defined in the form described above, but the inserted number may be variously set/defined according to examples.

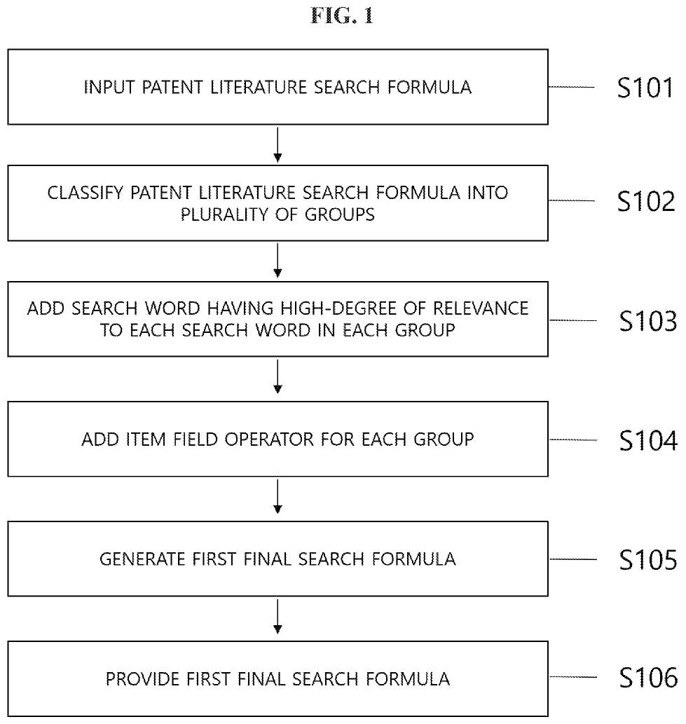

FIG. 1 is a flowchart illustrating an optimization method for a patent literature search formula according to an example of the present disclosure.

Depending on examples, at least one of the steps illustrated in the flowchart may be excluded or a new step may be added.

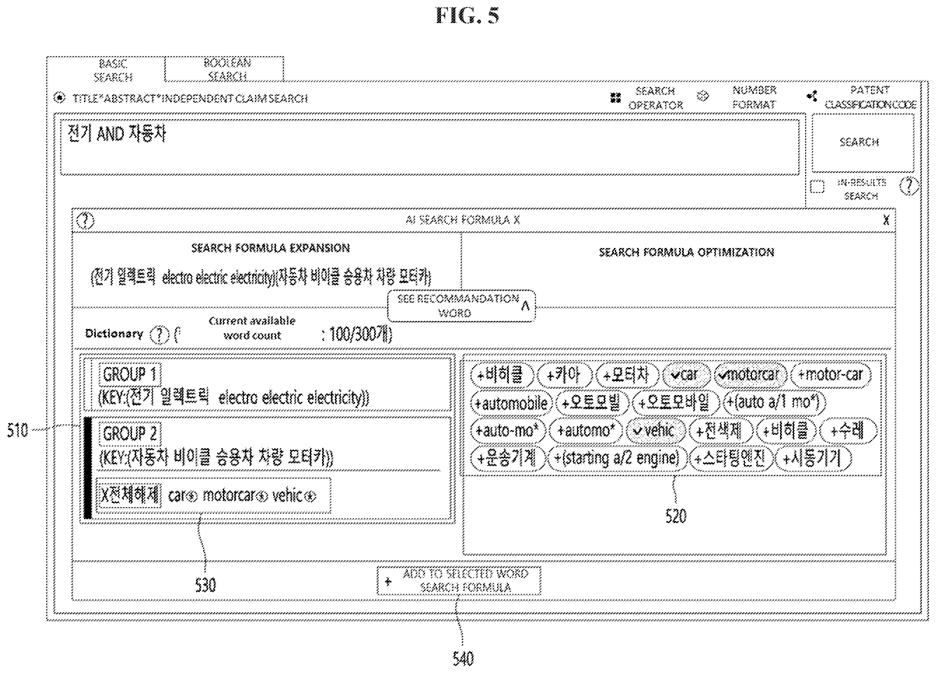

Referring to FIG. 1, a search formula optimization server may first receive a patent literature search formula from a user (S101). The patent literature search formula received here means not only the patent literature search formula input by the user directly by typing, but also may be interpreted as comprehensively meaning a patent literature search formula which is updated/edited/expanded/optimized by using at least one of the examples/functions proposed in this specification. For example, the patent literature search formula input in this step may be interpreted that a patent literature search formula that is expanded/optimized through this step includes a patent literature search formula updated/edited through examples of FIGS. 5 to 7 described below.

Since the patent literature search formula input by the user is expanded and optimized through the subsequent procedure, the user does not need to elaborately create the patent literature search formula to be input, and only a search word and simple search operator are used, which are considered the most essential for the patent literature to be searched to create and input the patent literature search formula.

Next, the search formula optimization server may classify the patent literature search formula into a plurality of groups based on a preset search operator (S102). At this time, an operator for classifying the plurality of groups may be set as various search operators, and for example, may correspond to at least one of an item field operator, the ‘and’ operator, the ‘or’ operator, the parenthesis operator, and the ‘Not’ operator. However, it is not limited thereto, and of course, various search operators to be used for group classification may be set by the user or a server administrator.

For example, it may be assumed that the following patent literature search formula is input.

Example (1) (( [symbol] organic) a/1 ( [symbol] emit* [symbol] )) [symbol] method) and ( [symbol] diode) (in which [symbol] (organic)’, ‘ [symbol] (light emission)’, ‘ [symbol] (fluorescence)’, [symbol] (diode)’, and ‘ [symbol] (method)’ are Korean words and these words may change from country to country, for example, Japanese, German, French, or the like, and the same applies the following description)

Example (2) key:( [symbol] ¹ a/1 [symbol] ²) and dsc:( [symbol] ³ atopic*) ¹ “ [symbol] ” is Korean text.² “ [symbol] ” is Korean text.³ “ [symbol] ” is Korean text.

In this case, when the preset operator is ‘and’, the examples may be classified into groups as follows.

### Example (1)

Group 1: ((( [symbol] organic) a/1 ( [symbol] emit* [symbol] )) [symbol] method))
Group 2: ( [symbol] diode)

### Example (2)

Group 1: key: ( [symbol] a/1 [symbol] )
Group 2: dsc: ( [symbol] atopic*)

In a case where the preset search operator for classifying groups corresponds to at least one of the item field operator and the ‘and’ operator, the ‘and’ operator included in a pair of parentheses operators among the ‘and’ operators may not be recognized as a search operator for the group classification. This is because it is an intention of the user to group search words enclosed in the pair of parentheses with the ‘and’ operator into one group.

In a case where there are a plurality of operators for classifying the plurality of groups, a priority order for grouping may be set among the plurality of operators. For example, a first search operator may be set to have a higher priority than a second search operator. In this case, the search formula optimization server primarily groups the patent literature search formulas based on the first search operator, and then may perform secondary grouping based on the second search operator for each group which is primarily grouped.

Next, the search formula optimization server may add a search word having a high-degree of relevance to each search word in each group by using the first search operator (S103).

In order to perform this step, the search formula optimization server learns in advance at least one of synonym data, near-synonym data, translated word data, original patent literature text data, translated version data of patent literature text, and search formula record data, and may construct a model for extracting a keyword having a high-degree of relevance to the search word based on a learning result. Based on the learning result, such a keyword extraction model may highly evaluate the relevance as the keyword corresponding to the synonym, the near-synonym, or the translated word of each search word, existing in the same patent document as each search word, or as a keyword at a position close within the same patent document. Various machine learning technologies and deep learning technologies may be used for learning.

The search formula optimization server may extract a preset number of keywords having the high-degree of relevance to each search word by using/based on the model constructed in this manner, and add the extracted keywords for each search word in each group by using the first search operator. The first search operator may be set as various search operators according to a policy of a businessman providing a patent search service. For example, the first search operator may be set as the ‘or’ operator or the ‘and’ operator. For example, in a case where a search word is added by using the ‘or’ operator, if there is a search word of ‘ [symbol] ⁴’ in the first group, the search formula optimization server may extract the ‘organic’, which is an translated word of ‘ [symbol] ’, as the keyword of the high-degree of relevance, and may connect the keyword by using the ‘ [symbol] ’ and ‘or’ operators. As a result, in the first group, ‘ [symbol] ’ is replaced with ‘ [symbol] or organic’ to add a search word having the high-degree of relevance. If there is a residual keyword that is not extracted due to a limit of a preset number of keywords among keywords having the high-degree of relevance to each search word, the search formula optimization server may provide the residual keyword as a recommended search word to the user. ⁴ “ [symbol] ” is Korean text.

Next, the search formula optimization server may add an item field operator for specifying an item to be searched among data items of the patent literature for each group (S104). To this end, the search formula optimization server may construct a model for extracting the data item having the highest probability of being searched for each group by learning at least one of the original patent literature text data and the translated patent literature text data by data item. The data item extraction model constructed in this manner may consider an average amount of each item when extracting a data item having the highest probability of being searched. More specifically, the data item extraction model may extract the data item of the highest probability of being searched by deriving the average amount of each data item and calculating the average number of times each group is searched within each data item compared to the average amount of each derived data item. For example, it may be assumed that the average amount of the claim is 5 words, and the average amount of the detailed description of the disclosure is 20 words. In this case, if the target search word/group is searched once on average in the claim, the search probability for the claim is 20% (=⅕), and if the target search word/group is searched once in the detailed description of the disclosure, the search probability for the detailed description of the disclosure may be derived as 5% (= 1/20). As a result, the data item extraction model extracts the claim having a higher probability of being searched as a data item having the highest probability of being searched.

The search formula optimization server may extract the data item having the highest probability of being searched for each group based on/using the model constructed in this manner, and add the item field operator for the extracted data item for each group.

For example, in the case of the group 1 in Example (1), the search formula optimization server may extract the most searched data items by inputting the group 1 (or at least one of the search words included in the group 1) into the data item extraction model. If the extracted data item is the claim, the search formula optimization server may add ‘CLA:’, which is an item field operator corresponding to the claim, to the group 1. As a result, the group 1 is created in a format such as ‘CLA: (( [symbol] organic) a/1 ( [symbol] emit* [symbol] )) [symbol] method)’, thereby adding an item field operator.

If, as in Example (2), in a case where there is a group in which the item data field is already inserted, the search formula optimization server may delete/exclude all the item data fields, and then add the newly extracted data item field by using the data item extraction model.

Next, the search formula optimization server may generate a first final search formula by connecting the group to which the item field operator is added by the second search operator and combining them into one search formula (S105). The second search operator may be set as various search operators according to the policy of the businessman providing the patent search service. For example, the second search operator may be set as the ‘and’ operator or the ‘or’ operator. A case where the second search operator is set to the ‘and’ operator is assumed to be the example (1) described above, for example, the first final search formula is completed by connecting the two groups through the ‘and’ operator such as ‘((( [symbol] organic) a/1 ( [symbol] emit* [symbol] method) and ( [symbol] diode)’.

Although not illustrated in this flowchart, as a result of performing step S104, a case where the same item field operator may be added for each group. In this case, the search formula optimization server may connect groups to which the same/duplicate item field operator is assigned through the preset operator (for example, ‘and’ or ‘or’ operator), and then the first final search formula may be generated by adding the same/duplicate item field operator for the connected groups.

For example, in a case where the item field operator newly assigned to the groups 1 and 2 in Example (1) is common as ‘CLA:’, the search formula optimization server may connect the groups 1 and 2 with ‘and’ and then adds ‘CLA:’ to generate the first final search formula. As a result, the first final search formula in the form of ‘CLA:(((( [symbol] organic) a/1 ( [symbol] emit* [symbol] method) and ( [symbol] diode))’ is generated.

Finally, the search formula optimization server may provide the generated first final search formula to the user (S106).

Although not illustrated in this flowchart, a step of inspecting the validity of the patent literature search formula may be preceded before proceeding the flowchart. For example, the search formula optimization server may proactively determine whether the pair of parentheses is properly included in the patent literature search formula input by the user, or whether there are typos, and guide the user to input a valid patent literature search formula.

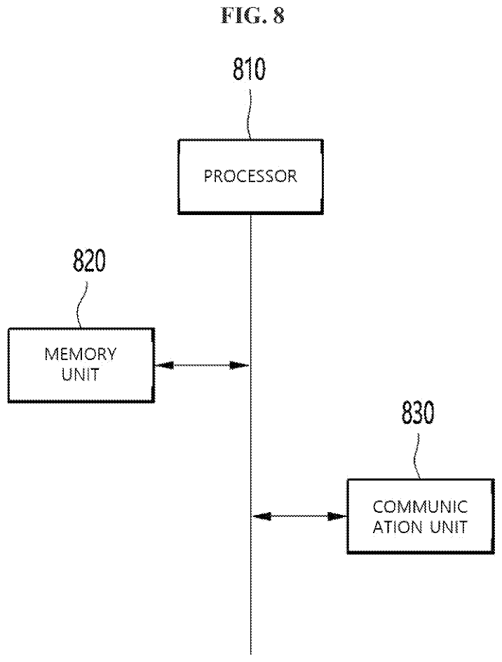

Each step in this flowchart may be described as an operation performed by a configuration element of the search formula optimization server (or device). For example, it may be interpreted that the first step is a step performed by a patent literature search formula input unit, the second step is a step performed by a group classification unit, the third step is a step performed by a search word addition unit, the fourth step is a step performed by an item field operator addition unit, the fifth step is a step performed by a first final search formula generation unit, and the last step is a step performed by a first final search formula providing unit. That is, the configuration elements of the search formula optimization server may be classified into functional configuration elements, and the configuration elements may be implemented as at least one hardware/software configuration element to perform each function. For example, it may be implemented as at least one of the configuration elements of the block diagram of FIG. 8.

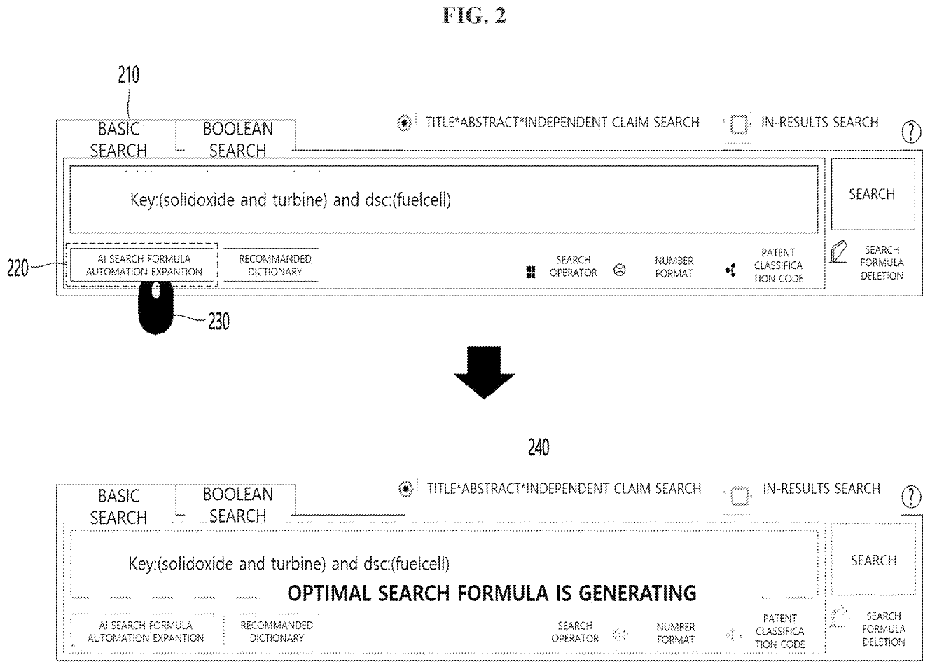

FIG. 2 is a diagram illustrating a screen configuration user interface (UI) for providing an optimization method for the search formula according to an example of the present disclosure.

Referring to FIG. 2, the search formula optimization server may basically provide a search formula input UI/window/function 210 for allowing the user to input the patent literature search formula, through which the user may input the patent literature search formula. Basically, the search formula optimization server may provide a search result for the patent literature search formula input by the user. Furthermore, the search formula optimization server may provide a search formula optimization icon 220 for receiving the user input for the search formula optimization method described above. The user may input a basic patent literature search formula through the search formula input UI/window/function, and if optimization thereof is desired, the search formula optimization icon 220 is clicked/selected/touched 230 to command/instruct the optimization for the patent literature search formula to the search formula optimization server.

When the search formula optimization server receives the search formula optimization command/instruction of the user, the search formula optimization server may perform the optimization according to the method proposed in FIG. 1 based on the patent literature search formula input into the search formula input UI/window/function 210.

While optimizing the patent literature search formula, the search formula optimization server may induce wait of the user during the optimization is in progress by providing the user with a graphic UI 240 indicating that the search formula is being optimized.

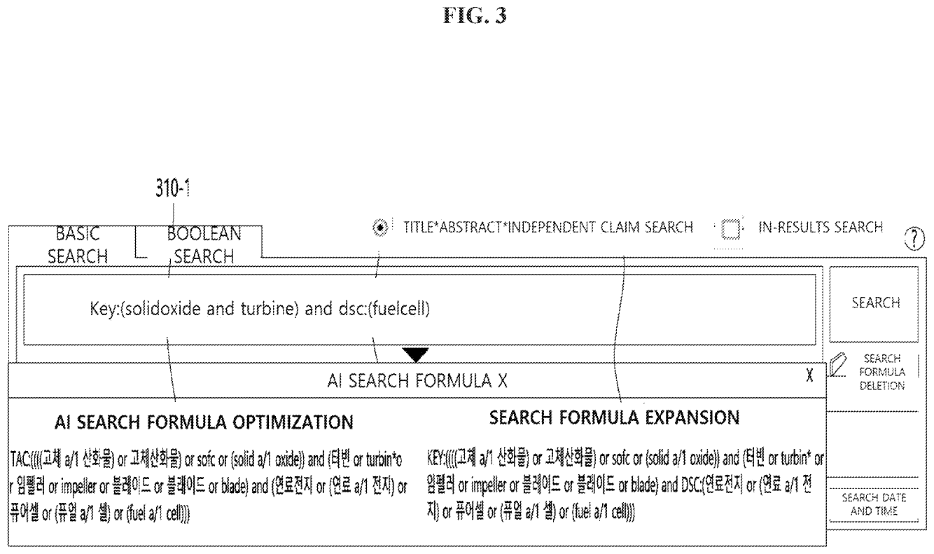

FIG. 3 is a diagram illustrating a screen configuration UI for providing a search formula optimization result according to an example of the present disclosure.

Referring to FIG. 3, the search formula optimization server may provide the user with a first final search formula 310-1 which is a result of optimizing the patent literature search formula input by the user.

Furthermore, the search formula optimization server may provide a second final search formula 310-2, which is a result of expanding the patent literature search formula input by the user, together with the first final search formula 310-1. The user may want to expand only the search word while maintaining a basic/overall frame of the search formula. In order to satisfy such a request of the user, the search formula optimization server of the present disclosure may provide the second final search formula 310-2, which is the result of only expansion of the patent literature search formula, while maintaining the overall frame of the patent literature search formula input by the user. In this case, the search formula optimization server performs the expansion for each search word in each group by performing steps S101 to S103 of FIG. 1, and may generate the second final search formula 310-2 by connecting and combining respective groups with the second search operator.

The search formula optimization server may provide 310 the first and second final search formulas that are optimization and expansion results at the same time, and provide a selection function to allow the user to select one of the two final search formulas 310-1 and 310-2. The user may select and input any one final search formula to be used for search between the provided first and second final search formulas 310-1 and 310-2, and the search formula optimization server may perform the search for the final search formula in which the selection input of the user is received.

In this specification, for convenience of description, the first and second final search formulas are separately described, but the meaning of each number of the terms is not limited, and it goes without saying that the first final search formula may be referred to and described as the second final search formula, and the second final search formula may be referred to and described as the first final search formula.

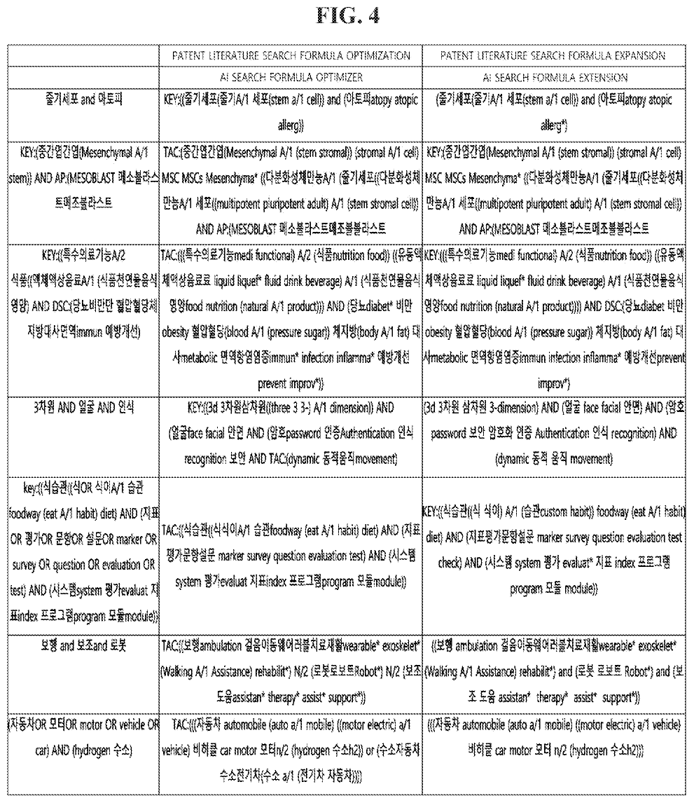

FIG. 4 is a table illustrating an arrangement of the first and second final search formulas which are the results of optimization and expansion of the patent literature search formula input by the user according to an example of the present disclosure.

Referring to FIG. 4, it may be seen that in the case of the first final search formula, a form in which all of the item field operators are inserted is generated, and in the case of the second final search formula, a form in which the search word is expanded is generated in a state where the frame of the patent literature search formula input by the user is maintained.

FIG. 5 is a diagram illustrating an example of a search word expansion function according to an example of the present disclosure.

Referring to FIG. 5, the search formula optimization server may provide the search word expansion function for allowing the user to directly select the search word to be expanded.

More specifically, the search formula optimization server may receive the patent literature search formula from the user and classify it into a plurality of groups. Description of this may be replaced by the description of steps S101 and S102 described above with reference to FIG. 1.

The search formula optimization server may provide the user with the results classified into a plurality of groups in a form of a notification window 510 (group 1 and group 2 in this drawing), and with a group selection function in which the user may select and input the group to which the search word/search formula expansion is to be performed. In this case, the user may select a group to be expanded, and the search formula optimization server may provide the user with information on the expansion target group by displaying the window of the selected group active (in this drawing, the window of group 1).

The search formula optimization server may extract the keyword having the high-degree of relevance to each group by using a keyword extraction model. The search formula optimization server may provide the keyword for the selected group according to a group selection input of the user. In this case, as illustrated in this drawing, the search formula optimization server may provide 520 each keyword in a form of an icon so that the user may select and input the keyword. When receiving the selection input of the user for the keyword icon, the search formula optimization server may activate the selected keyword icon, and display 530 information on the activated keyword at a lower end of the window of the activated group. In this case, the search formula optimization server may display 530 a function icon for commanding cancellation/release of all the selected keywords at the lower end of the window of the group together with the display of the activated keywords.

The search formula optimization server may provide an ‘adding to selected word keyword’ function icon 540 for receiving a command to perform group addition of the selected keyword from the user, and upon receiving a user input for this 540, may generate the patent literature search formula by adding the currently active keyword to the corresponding (or currently active displayed) group as a search word adding a keyword as a search word.

The user may expand/optimize the patent literature search formula by repeatedly performing the present example, and may complete the high-quality patent literature search formula by continuously updating the patent literature search formula to a level of satisfaction of the user.

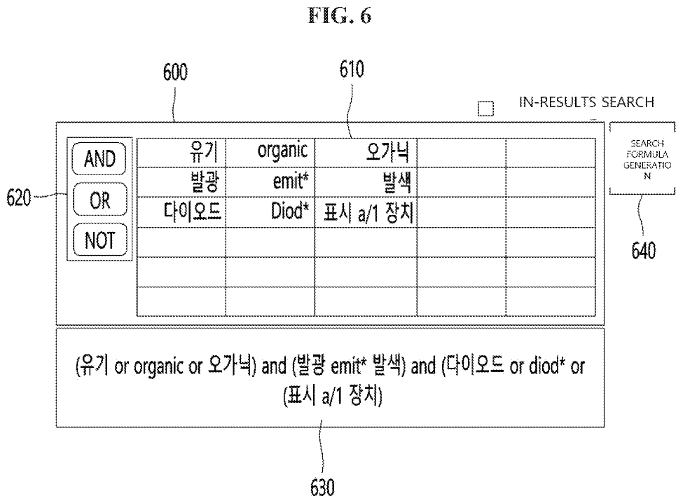

FIG. 6 is a diagram illustrating an example of a search formula assistance UI according to an example of the present disclosure.

The search formula optimization server may provide a search formula assistance UI 600 that automatically completes a final search formula by using only a search word input from the user. In particular, the search formula assistance UI 600 may complete the final search formula by using a positional relationship between the input search words.

As an example, as illustrated in this drawing, the search formula assistance UI 600 may be configured in a table form 610 in which an input window, into which a plurality of search words are input, is configured of a plurality of rows and columns. The search word input into the search formula assistance UI 600 may be connected through a preset search operator according to a positional relationship with another search word.

For example, the search formula optimization server may complete a simple search formula by primarily connecting search words input into the search formula assistance UI 600 in a row direction. Next, the search formula optimization server may secondarily connect the simple search formulas completed for each row in a column direction to complete the final search formula. However, the present disclosure is not limited thereto, and the search formulas may be connected firstly in the column direction and then secondly connected in the row direction.

The connection may be performed through a preset search operator, which may be performed through the ‘or’ and parentheses operators in the row direction and may be performed through the ‘and’ operator in the column direction. More specifically, the search formula optimization server may complete the simple search formula by connecting search words input in the row direction with the ‘or’ operator and then grouping them with the parentheses operator, and complete the final search formula by connecting each simple search formula completed in the row direction by using the ‘and’ operator in the column direction.

However, the example of the present disclosure is not limited thereto, and of course, various search operators may be set for various directions such as row, column, and diagonal directions.

In addition, as illustrated in this drawing, the search formula optimization server may provide a selection icon 620 for the basic search operators to select and input the basic search operators, (in this drawing, icons for the ‘and’, ‘or’ and ‘not’ operators are provided), and the user may generate/edit a patent literature search formula in more detail by performing selection input for these icons 620 as well as the search word.

The search formula assistance UI 600 may provide a preview function 630 for the patent literature search formula completed to date according to the input of the user, and provide a search formula generation function 640 for instructing/commanding generation of the same search formula as the patent literature search formula which is provided in the preview function 630. The user may check the patent literature search formula that is completed to date through the preview function 630, and if it is determined that the patent literature search formula is completed, the user may select the search formula generation function 640 to complete the final patent literature search formula.

According to an example of the present disclosure, since the patent literature search formula is easily completed by only inputting a simple search word by the user, there is an effect that the user does not need to know all the search operators, and the time and effort required to create a complex patent literature search formula are greatly reduced.

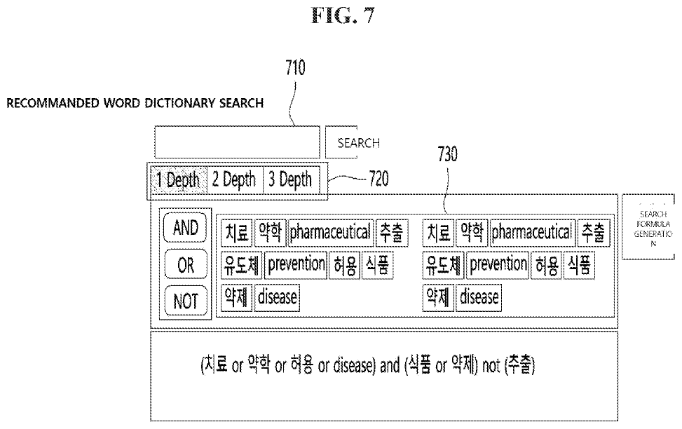

FIG. 7 is a diagram illustrating an example of a search word recommendation UI according to an example of the present disclosure.

The search formula optimization server may provide the search word recommendation UI for recommending a search word to the user. As in the examples described above, the search formula optimization server may directly optimize the patent literature search formula input by the user, and when the user inputs a search word, for this, optimization may be performed by recommending various expandable keywords 730.

The search formula optimization server may receive 710 a search word from the user through the search word recommendation UI and extract at least one keyword 730 having the high-degree of relevance to the input search word by using a keyword extraction model. Furthermore, the search formula optimization server may provide the user with the extracted keyword 730 as a recommended search word. In this case, the search formula optimization server may classify the extracted keyword 730 into a plurality of depths/levels 720 according to the degree of relevance to the input search word and provide it as the recommended search word.

For example, in a case where the extracted keyword 730 corresponds to the synonym or the translated word of the input search word, the keyword 730 may be provided as a first depth/level (example in this drawing), in a case where the extracted keyword 730 corresponds to a similar word or a compound word of the search word, the keyword 730 may be provided as a second depth/level, and in a case where the extracted keyword 730 corresponds to an expanded keyword of the similar word or the compound word, the keyword 730 may be provided as a third depth/level, respectively. In this case, the keyword of the third depth/level may be derived by extracting the keyword having the high-degree of relevance to the similar word or the compound word by using the keyword extraction model described above.

That is, the search formula optimization server may classify the depth/level 720 with respect to the search word input by the user according to the degree of relevance, and recommend the search word 730 in stages according to the classified depth/level 720. In a case where too many search words 730 are recommended at once, the user may be confused as to which search word to select. Accordingly, the present disclosure provides the recommended search word 730 in stages according to the degree of relevance, thereby helping the user to more easily and efficiently borrow the search word.

The search formula optimization server may provide a patent literature search formula generation function to directly generate the patent literature search formula by using the search word 730 recommended through the search word recommendation UI. To this end, in the search word recommendation UI, the recommended search word 730 and the search operator may be provided in a form of an icon selectable by a user, and a preview function for a patent literature search formula being generated may also be provided. Accordingly, the user may directly generate the patent literature search formula by selecting the recommended search word 730 and the search operator through the search word recommendation UI, and may immediately check the patent literature search formula generated to date through the preview function.

FIG. 8 is a block diagram of the search formula optimization server according to an example of the present disclosure.

Referring to FIG. 8, the search formula optimization server may include a processor 810, a memory unit 820, and a communication unit 830. Each configuration element may be implemented through at least one hardware/software configuration element.

The memory unit 820 may store various digital data such as video, audio, photo, moving image, application, and file. The memory unit 820 represents various digital data storage spaces, such as a flash memory, a hard disk drive (HDD), and a solid state drive (SSD).

The communication unit 830 may perform communication with an outside of the device by using various protocols and transmit/receive data. The communication unit 830 may transmit/receive digital data by connecting to an external network by wire or wirelessly.

The processor 810 may execute various applications stored in the memory unit 820 and process data. Further, the processor 810 may control at least one unit to perform the examples described in this specification. Therefore, the processor 810 may be described as being replaced with the search formula optimization server. The processor 810 may be configured to include a central processing unit (CPU), a micro processor unit (MPU), a micro controller unit (MCU), an application processor (AP), or a processor of any form well known in the technical field of the present disclosure.

The description of this block diagram may be equally applied to a search formula optimization device.

The example according to the present disclosure may be implemented by various means, for example, hardware, firmware, software, a combination thereof, or the like. In a case of implementation by hardware, an example of the present disclosure may be implemented by one or more of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In addition, in a case of implementation by firmware or software, an example of the present disclosure may be implemented in a form of a module, a procedure, a function, or the like that performs the functions or operations described above, and may be stored in a recording medium that may be read through various computer means. Here, the recording medium may include a program command, a data file, a data structure, or the like alone or in combination. A program command recorded on the recording medium may be specially designed and constructed for the present disclosure or may be known and usable to those skilled in computer software. For example, the recording medium includes magnetic media such as hard disks, floppy disk, and magnetic tape, optical media such as compact disk read only memory (CD-ROM) and digital video disk (DVD), magnetic-optical media such as a floptical disk, and a hardware device specially configured to store and execute a program command such as ROM, RAM, and flash memory. Examples of the program command may include not only machine language codes such as those produced by a compiler but also high-level language codes that may be executed by a computer by using an interpreter or the like. Such a hardware device may be configured to operate as one or more software modules to perform the operations of the present disclosure, and vice versa.

In addition, the device or terminal according to the present disclosure may be driven by a command that causes one or more processors to perform the functions and processes described above. For example, such a command may include an interpreted command such as a script command of a JavaScript or ECMAScript command, an executable code, or other commands stored in a computer-readable medium. Further, the device according to the present disclosure may be implemented in a distributed type over a network, such as a server farm, or may be implemented in a single computer device.

In addition, a computer program (also known as a program, software, software application, script, or code) mounted on the device according to the present disclosure and executing the method according to the present disclosure may be created in any form of programming language including a compiled or interpreted language, or a priori or procedural language. The computer program may be deployed in any form including a standalone program, a module, a component, a subroutine, or other units suitable for use in a computer environment. The computer program does not necessarily correspond to a file in a file system. The program may be stored in a single file provided in a requested program, in multiple interactive files (for example, files that store one or more modules, subprograms or a part of the code), or in a part (for example, one or more scripts stored in a markup language document) of the file that hold other programs or data. The computer program may be deployed to be executed on one computer or multiple computers located at one site or distributed over a plurality of sites and interconnected by a communication network.

For convenience of description, each drawing is described separately, but it is possible to design a new example by merging the examples described in respective drawings. In addition, the present disclosure is not limitedly applicable to the configuration and method for the examples as described above, but the examples described above may be configured by selectively combining all or a part of each example so that various modifications may be provided.

In addition, although preferred examples are illustrated and described above, this specification is not limited to the specific examples described above, and without departing from the subject matter claimed in the claims, various modifications are possible by those having ordinary knowledge in the technical field to which the specification belongs, and these modifications should not be individually understood from the technical idea or perspective of this specification.

What is claimed is:

1. An optimization method for a patent literature search formula, comprising:
a step of receiving the patent literature search formula;
a step of classifying the received patent literature search formula into a plurality of groups based on a preset search operator;
a step of adding at least one search word having a high-degree of relevance to each search word included in each classified group by using a first search operator;
a step of generating a first final search formula by connecting and combining, with a second search operator, a plurality of groups to which the at least one search word is added; and
a step of providing a user with the first final search formula.

2. The optimization method for a patent literature search formula of claim 1,
wherein the first search operator is an ‘or’ operator or an ‘and’ operator, and the second search operator is the ‘and’ operator or the ‘or’ operator.

3. The optimization method for a patent literature search formula of claim 1,
wherein the preset search operator corresponds to at least one of the item field operator, the ‘and’ operator, the ‘or’ operator, a parenthesis operator, and a ‘not’ operator.

4. The optimization method for a patent literature search formula of claim 3,
wherein the preset search operator excludes an ‘and’ operator included in a pair of parenthesis operators ( ) among the ‘and’ operators.

5. The optimization method for a patent literature search formula of claim 1, further comprising:
a step of constructing a model for extracting a keyword having a high-degree of relevance to each search word by learning at least one of synonym data, near-synonym data, translated word data, original patent literature text data, translated version data of the patent literature text, and search formula record data.

6. The optimization method for a patent literature search formula of claim 5,
wherein the degree of relevance is a keyword corresponding to a synonym, a near-synonym, or a translated word of each search word, or
is evaluated higher as the keyword exists in the same patent literature as each search word, and the closer the keyword is in the same patent literature.

7. The optimization method for a patent literature search formula of claim 5,
wherein the step of adding the at least one search word includes:
a step of extracting as many as a preset number of keywords having a high-degree of relevance to each search word based on the constructed model; and
a step of adding the extracted keyword as the at least one search word.

8. The optimization method for a patent literature search formula of claim 7, further comprising:
a step of providing the user with a residual keyword as a recommended search word, in a case where there is the residual keyword that is not extracted due to a limit of the preset number among the keywords having the high-degree of relevance to each search word.

9. The optimization method for a patent literature search formula of claim 5, further comprising:
a step of receiving a search word from the user;
a step of extracting at least one keyword having a high-degree of relevance to the search word by using the constructed model; and
a step of providing the user with the extracted keyword as a recommended search word.

10. The optimization method for a patent literature search formula of claim 9,
wherein the step of providing the user with the extracted keyword is a step of providing the extracted keyword as the recommended keyword by classifying the extracted keyword into a plurality of depths according to a degree of relevance to the received keyword.

11. The optimization method for a patent literature search formula of claim 10,
wherein the plurality of depths includes:
a first depth in which the extracted keyword corresponds to the synonym or the translated word of the search word, and
a second depth in which the extracted keyword corresponds to a similar word or a compound word of the search word.

12. The optimization method for a patent literature search formula of claim 1, further comprising:
a step of adding an item field operator for specifying an item to be searched among data items of patent literature for each group after the addition using the first search operator;
a step of generating a second final search formula by connecting and combining, with the second search operator, a plurality of groups to which the item field operator is added; and
a step of providing the user with the second final search formula.

13. The optimization method for a patent literature search formula of claim 12, further comprising:
a step of constructing a model for extracting a data item having a highest probability of searching the each group by classifying and learning at least one of original patent literature text data and translated patent literature text data for the each data item.

14. The optimization method for a patent literature search formula of claim 13,
wherein the data item includes at least one of title of the disclosure, abstract, claim, independent claim, detailed description, background art, technical field, effect of the disclosure, and drawing.

15. The optimization method for a patent literature search formula of claim 13,
wherein the step of adding the item field operator includes:
a step of extracting a data item having the highest probability of searching the each group based on the constructed model; and
a step of adding, for each group, an item field operator for the data item extracted for each group.

16. The optimization method for a patent literature search formula of claim 15,
wherein a step of extracting the data item having the highest probability of searching the each group includes:
a step of deriving an average amount for each data item; and
a step of extracting the data item having the highest probability of being searched by calculating an average number of times the each group is searched in the each data item compared to a derived average amount of each data item.

17. The optimization method for a patent literature search formula of claim 12,
wherein in a case where there are groups in which the item field operator overlaps among the plurality of groups, the step of adding the item field operator includes:
a step of connecting groups having the same item field operator with a preset search operator; and
a step of adding the same item field operator to the connected groups.

18. The optimization method for a patent literature search formula of claim 12,
wherein as a result of the group classification, in a case where at least one item field operator is included in each of the classified groups, the step of adding at least one search word having the high-degree of relevance is a step of adding the at least one search word after removing the at least one item field operator.

19. The optimization method for a patent literature search formula of claim 1, further comprising:
a step of providing a search formula assistance user interface (UI) for receiving a plurality of search words from the user and completing a final search formula by using a positional relationship of the received search words.

20. The optimization method for a patent literature search formula of claim 19,
wherein the search formula assistance UI provides an input window into which the plurality of search words are input in a table format configured of a plurality of rows and columns, and connects the input search words in a row direction to complete a simple search formula, and then connects simple search formulas completed for each row in a column direction to complete the final search formula,
wherein the simple search formula is completed by connecting search words input in the row direction with the ‘or’ operator and then grouping them with the parenthesis operator, and
wherein the final search formula is completed by connecting each simple search formula completed in the row direction by using the ‘and’ operator in the column direction.

21. A web server that optimizes a patent literature search formula, comprising:
a communication unit that transmits and receives data by using at least one communication protocol;
a memory unit that stores the data; and
a processor that controls the communication unit and the memory unit,
wherein the processor
receives the patent literature search formula,
classifies the received patent literature search formula into a plurality of groups based on a preset search operator,
adds at least one search word having a high-degree of relevance to each search word included in each classified group by using a first search operator,
adds an item field operator for specifying an item to be searched among data items of the patent literatures for each group,
generates a first final search formula by connecting and combining, with a second search operator, a plurality of groups to which the item field operator is added, and
provides a user with the first final search formula.
